(19) United States
(12) Patent Application Publication
(10) Pub. No.: US 2026/0358682 A1
(43) Pub. Date: Nov. 12, 2026

(54) LENS BARREL AND IMAGING DEVICE EQUIPPED WITH SAME

(71) Applicant: Panasonic Intellectual Property Management Co., Ltd., Osaka (JP)

(72) Inventors: Yuichiro KIMOTO, Osaka (JP); Tatsuhiro ENOMOTO, Nara (JP); Yasuto SUZUKI, Osaka (JP); Atsushi HASEGAWA, Osaka (JP)

(73) Assignee: Panasonic Intellectual Property Management Co., Ltd., Osaka (JP)

(21) Appl. No.: 19/658,486

(22) Filed: Apr. 25, 2026

(30) Foreign Application Priority Data
May 8, 2025 (JP) 2025-078240

(51) Int. Cl. G03B 17/14

(52) U.S. Cl. CPC G03B 17/14

(57) ABSTRACT

A lens barrel 10 is provided with a substantially cylindrical fourth lens group unit 21, a fifth lens group unit 23, a position detection unit 24, and a protrusion 23c. The fifth lens group unit 23 is provided on the inner peripheral surface side of the fourth lens group unit 21 in a state of being movable in the optical axis direction of a lens L5. The position detection unit 24 has a light emitting unit 24a, a reflecting plate 24b, and a light receiving unit 24c, and detects the position of the fifth lens group unit 23 relative to the fourth lens group unit 21 on the basis of the change in the amount of light received by the light receiving unit 24c. The protrusion 23c is provided at a position on the image plane side of the fifth lens group unit 23, which is on the opposite side from the subject in the optical axis direction, and is provided so as to protrude outward in the radial direction beyond the light emitting unit 24a.

### CROSS-REFERENCE TO RELATED APPLICATIONS

This application claims priority to Japanese Patent Application No. 2025-078240 filed on May 8th, 2025. The entire disclosure of Japanese Patent Application No. 2025-078240 is hereby incorporated herein by reference.

### BACKGROUND

### Technical Field

The present disclosure relates to a lens barrel that uses an optical position detection unit to detect the position of a movable frame, and to an imaging device equipped with this lens barrel.

### Description of the Related Art

For example, Patent Literature 1 discloses a lens barrel that includes a zoom lens movement frame that holds a zoom lens on the inside, a lens barrel main body that holds the zoom lens moving frame on the inside in a state of being movable in the optical axis direction along with the zoom lens, and a position detection device that detects the position in the optical axis direction of the zoom lens movement frame held on the inside of the lens barrel main body, wherein the position detection device has an optical sensor and a sensor detection target, and the sensor detection target includes a sensor cut portion that is directly detected, and a sensor cover that covers the optical sensor together with the sensor cut portion during position detection.

### CITATION LIST

### Patent Literature

Patent Literature 1: JP-A2007-121738

### SUMMARY

### Problem to be Solved by the Invention

However, the following problem is encountered with the above-mentioned conventional lens barrel.

That is, with the lens barrel disclosed in the above publication, a sensor cover that prevents ambient light from entering the optical sensor is provided in order to prevent erroneous detection when detecting the position of the zoom lens movement frame.

However, with this configuration, even though erroneous detection due to the intrusion of external light can be prevented, a configuration that features an optical position detection unit to detect the position of the lens movement frame does not take into account that leaked light coming from the light emitting unit of the optical position detection unit can adversely affect the imaging element on the camera body side.

It is an object of the present disclosure to provide a lens barrel, and an imaging device equipped with this lens barrel, with which leaked light emitted from the light emitting unit of the position detection unit can be prevented from adversely affecting the imaging element on the camera body side in a configuration featuring an optical position detection unit for detecting the position of a lens movement frame, and to do so with a simple configuration.

### Means for Solving Problem

The lens barrel according to the present disclosure includes a substantially cylindrical first outer frame, a lens movement frame, a position detection unit, and a protrusion. The lens movement frame holds a lens and is disposed on the inner peripheral surface side of the first outer frame in a state of being movable in the optical axis direction of the lens. The position detection unit has a light emitting unit that emits light, a reflecting unit that is provided at a position opposite the light emitting unit and reflects the light emitted from the light emitting unit, and a light receiving unit that receives the light reflected by the reflecting unit. The position detection unit detects the position of the lens movement frame relative to the first outer frame on the basis of the change in the amount of light received by the light receiving unit. The protrusion is provided at a position on the image plane side of the lens movement frame, which is on the opposite side from the subject in the optical axis direction, and is provided so as to protrude outward in the radial direction beyond the light emitting unit.

### Effects

According to the lens barrel of the present disclosure, in a configuration featuring an optical position detection unit for detecting the position of a lens movement frame, a simple configuration can be used to prevent leaked light emitted from a light emitting unit of the position detection unit from adversely affecting an imaging element on the camera body side.

### BRIEF DESCRIPTION OF THE DRAWINGS

FIG. 1 is an overall oblique view of the state in which the lens barrel according to an embodiment of the present disclosure has been removably attached to a camera body;

FIG. 2 is an oblique view of the configuration of the lens barrel in FIG. 1;

FIG. 3 is an exploded oblique view of the configuration of the lens barrel in FIG. 1;

FIG. 4 is a front view of the lens barrel in FIG. 1 as seen from the subject side in the optical axis direction;

FIG. 5 is a cross-sectional view along the AF-AF line in FIG. 4;

FIG. 6 is an oblique view of the configuration of a third lens group unit and a fourth-fifth lens group unit included in the lens barrel in FIG. 3;

FIG. 7 is an exploded oblique view of the configuration of the third lens group unit and the fourth-fifth lens group unit in FIG. 6;

FIG. 8 is an exploded oblique view of the configuration of the drive unit side of the fourth-fifth lens group unit in FIG. 7;

FIG. 9 is an oblique view of the configuration of the fourth lens group unit included in the fourth-fifth lens group unit in FIG. 7;

FIG. 10 is an oblique view of the configuration of the fifth lens group unit included in the fourth-fifth lens group unit in FIG. 7;

FIG. 11 is a front view of the fifth lens group unit of FIG. 10 as viewed from the image plane side in the optical axis direction;

FIG. 12 is a cross-sectional view along the V-V line in FIG. 11;

FIG. 13 is a front view of the third lens group unit, the fourth lens group unit and the fifth lens group unit included in the fourth-fifth lens group unit, and the outer frame in FIG. 6, as viewed from the image plane side in the optical axis direction;

FIG. 14 is a front view of the third lens group unit and the fourth-fifth lens group unit in FIG. 6 in a state of being combined, as viewed from the image plane side in the optical axis direction;

FIG. 15A is a cross-sectional view along the AA-AA line in the configuration of FIG. 14, showing a state in which the fifth lens group unit is at the extreme position on the subject side;

FIG. 15B is a cross-sectional view along the AA-AA line in the configuration of FIG. 14, showing a state in which the fifth lens group unit is at the extreme position on the image plane side;

FIG. 16 is a detail view of the E portion in FIG. 15A;

FIG. 17A is a side view showing a state in which the fourth and fifth lens group units in FIG. 7 are combined;

FIG. 17B is a cross-sectional view along the W-W line in FIG. 17A; and

FIG. 18 is a detail view of the X portion in FIG. 17B.

### DETAILED DESCRIPTION OF THE EMBODIMENT

Embodiments will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

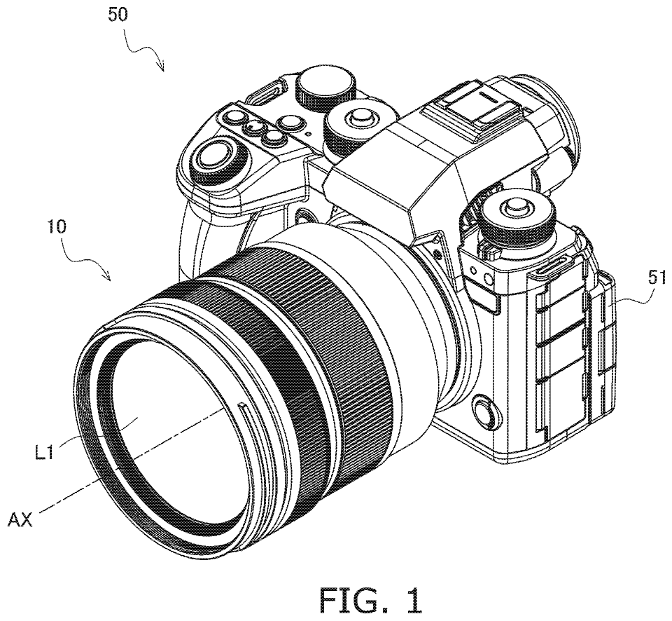

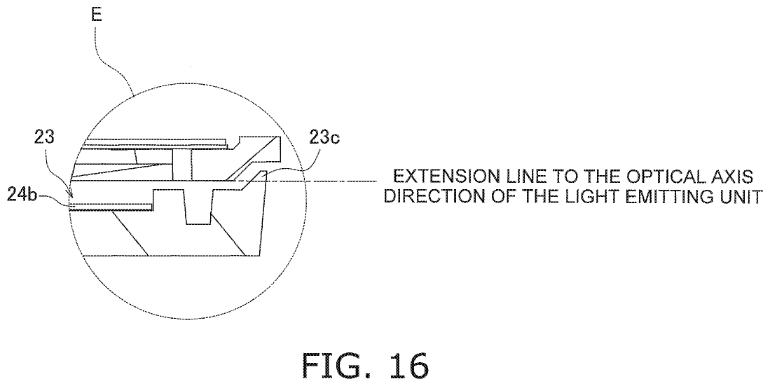

The lens barrel 10 according to an embodiment of the present disclosure and a camera (imaging device) 50 equipped with this lens barrel will now be described with reference to FIGS. 1 to 18.

### (1) Configuration of Camera 50

As shown in FIG. 1, the camera (imaging device) 50 according to this embodiment includes the lens barrel 10 and a camera body 51.

The lens barrel 10 is removably attached to the camera body 51. The detailed configuration of the lens barrel 10 will be described below.

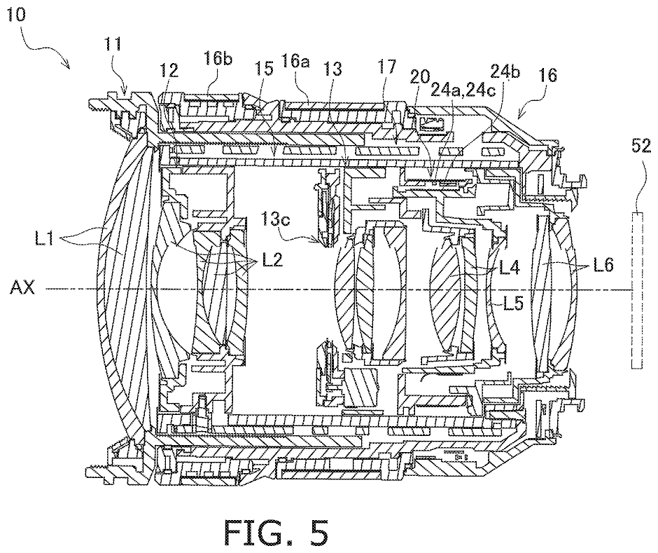

The camera body 51 captures an image of a subject through the lens barrel 10 with an imaging element 52 (see FIG. 5) mounted inside, and thereby produces image data.

### (2) Overall Configuration of Lens Barrel 10

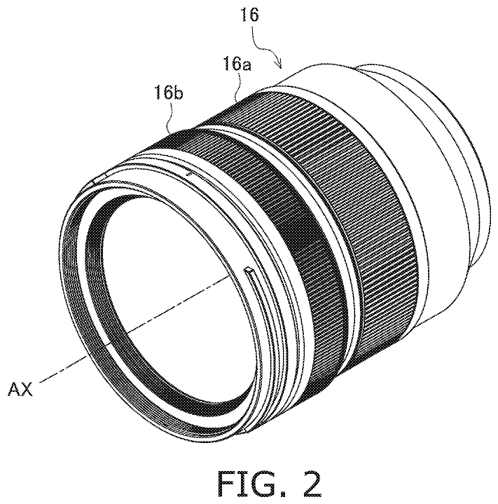

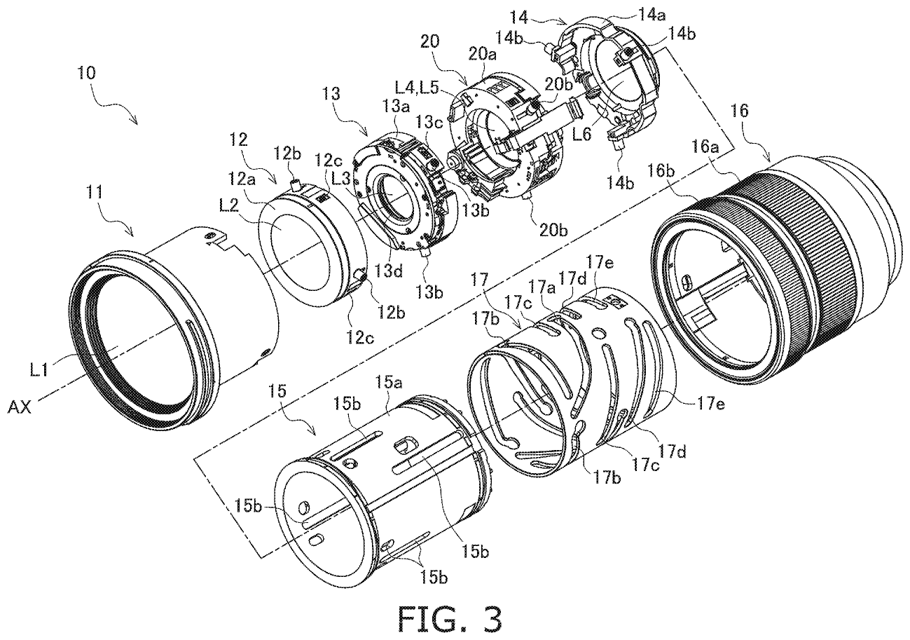

The lens barrel 10 according to this embodiment is removably attached to the camera body 51. As shown in FIGS. 2 and 3, the lens barrel 10 includes a first lens group unit 11, a second lens group unit 12, a third lens group unit (third outer frame) 13, a fourth-fifth lens group unit 20, a sixth lens group unit 14, a rectilinear guide barrel 15, a cam barrel 17, and an exterior unit 16.

As shown in FIGS. 2 and 3, the first lens group unit 11 is a substantially cylindrical member that is disposed the closest to the subject in the optical axis AX direction out of all the components constituting the lens barrel 10, and holds a lens (first lens group) L1 on its inner peripheral surface side. The first lens group unit 11 has a cam follower (not shown) that moves in a state of being engaged with a cam groove 17a of a cam barrel 17 (discussed below), and is moved back and forth in the optical axis AX direction as the cam barrel 17 rotates relative to a rectilinear guide barrel 15.

As shown in FIG. 3, the second lens group unit (second lens frame) 12 holds a lens L2, and moves back and forth in the optical axis AX direction on the inner peripheral surface side of the rectilinear guide barrel 15 as the cam barrel 17 rotates relative to the rectilinear guide barrel 15. The second lens group unit 12 has a substantially cylindrical main body portion 12a and cam followers 12b that protrude outward in the radial direction around the optical axis AX.

Three cam followers 12b are disposed at approximately equal angular intervals (about 120 degrees) on the outer peripheral surface of the substantially cylindrical main body portion 12a. The cam followers 12b move in a state of being engaged with cam grooves 17b of the cam barrel 17 (discussed below), which moves the second lens group unit 12 back and forth in the optical axis AX direction as the cam barrel 17 rotates relative to the rectilinear guide barrel 15.

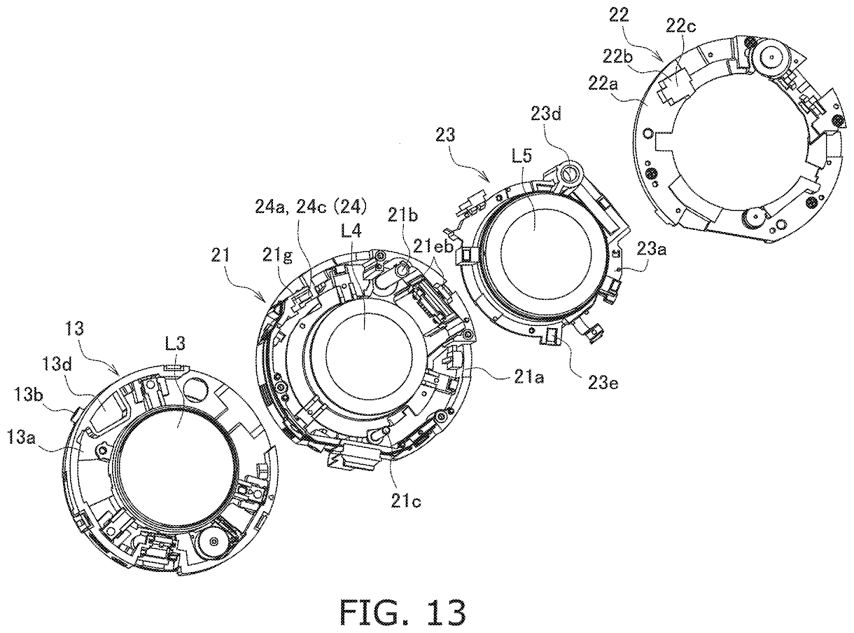

As shown in FIG. 3, the third lens group unit (third outer frame) 13 holds a lens L3, and has a substantially cylindrical main body portion 13a, cam followers 13b, an aperture unit 13c, and an enclosure 13d (see FIG. 13, etc.).

Three cam followers 13b are disposed at approximately equal angular intervals (about 120 degrees) on the outer peripheral surface of the substantially cylindrical main body portion 13a. The cam followers 13b move in a state of being engaged with cam grooves 17c of the cam barrel 17 (discussed below), which moves the third lens group unit 13 back and forth in the optical axis AX direction as the cam barrel 17 rotates relative to the rectilinear guide barrel 15.

The aperture unit 13c is disposed on the subject side of the main body portion 13a in the optical axis AX direction, and adjusts the amount of light incident from the subject side that passes through the lens barrel 10 by opening and closing aperture blades (not shown) to change the opening surface area.

The enclosure 13d is provided in a concave shape on the subject-side surface of the main body portion 13a of the third lens group unit 13 in the optical axis AX direction.

The fourth-fifth lens group unit (first lens frame) 20 is a linear focus unit that adjusts the focal length by moving a focus lens or other such lens L5 contained therein back and forth in the optical axis AX direction when, for example, a focus ring 16b rotatably attached to the outer peripheral surface of the exterior unit 16 is turned. As shown in FIG. 3, the fourth-fifth lens group unit 20 holds lenses L4 and L5, and has a substantially cylindrical main body portion 20a and cam followers 20b.

Three cam followers 20b are disposed at approximately equal angular intervals (about 120 degrees) on the outer peripheral surface of the substantially cylindrical main body portion 20a. The cam followers 20b move in a state of being engaged with the cam grooves 17d of the cam barrel 17 (discussed below), which moves the fourth-fifth lens group unit 20 back and forth in the optical axis AX direction as the cam barrel 17 rotates relative to the rectilinear guide barrel 15.

The configuration of the fourth-fifth lens group unit 20 will be described in detail below.

As shown in FIG. 3, the sixth lens group unit 14 holds a lens L6, and moves back and forth in the optical axis AX direction on the inner peripheral surface side of the rectilinear guide barrel 15 as the cam barrel 17 rotates relative to the rectilinear guide barrel 15. The sixth lens group unit 14 has a substantially cylindrical main body portion 14a and cam followers 14b that protrude outward in the radial direction around the optical axis AX.

Three cam followers 14b are disposed at approximately equal angular intervals (about 120 degrees) on the outer peripheral surface of the substantially cylindrical main body portion 14a. The cam followers 14b move in a state of being engaged with the cam grooves 17e of the cam barrel 17 (discussed below), which moves the sixth lens group unit 14 back and forth in the optical axis AX direction as the cam barrel 17 rotates relative to the rectilinear guide barrel 15.

As shown in FIG. 3, the rectilinear guide barrel 15 is a substantially cylindrical member that is disposed adjacent to the inner peripheral surface side of the cam barrel 17, and the second lens group unit 12, third lens group unit 13, the fourth-fifth lens group unit 20, and the sixth lens group unit 14 are disposed on the inner peripheral surface thereof. The rectilinear guide barrel 15 has a substantially cylindrical main body portion 15a and rectilinear grooves 15b.

The rectilinear grooves 15b are through-grooves formed along the optical axis AX direction, and the cam followers 12b, 13b, and 20b provided to the second lens group unit 12, the third lens group unit 13, the fourth-fifth lens group unit 20, the sixth lens group unit 14, etc., move in a state of being engaged with these grooves.

The cam barrel 17 is, for example, a substantially cylindrical member formed from aluminum, and as shown in FIG. 3, is disposed on the outer peripheral surface side of the rectilinear guide barrel 15 and drives the second lens group unit 12, the third lens group unit 13, the fourth-fifth lens group unit 20, and the sixth lens group unit 14 back and forth in the optical axis AX direction by rotating relative to the rectilinear guide barrel 15. As shown in FIG. 3, the cam barrel 17 has a substantially cylindrical main body portion 20a and a plurality of cam grooves 17a, 17b, 17c, 17d, and 17e formed in the main body portion 20a.

The cam barrel 17 is configured such that the cam grooves 17a, 17b, 17c, 17d, and 17e are formed on a substantially cylindrical aluminum member by cutting process.

As shown in FIGS. 2 and 3, the exterior unit 16 is a substantially cylindrical member that constitutes the exterior portion of the lens barrel 10, and has a circular zoom ring 16a, a focus ring 16b, etc., attached to its outer peripheral surface so as to be rotatable in the circumferential direction.

As shown in FIGS. 2 and 3, zoom ring 16a is a substantially annular member provided near the approximate center of exterior unit 16 in the optical axis AX direction, and is turned to move lens barrel 10 from its WIDE position (see FIG. 5) to its TELE position. As the zoom ring 16a rotates, the cam barrel 17 also rotates, causing first lens group unit 11, the second lens group unit 12, the third lens group unit 13, the fourth-fifth lens group unit 20, and the sixth lens group unit 14 to move back and forth in the optical axis AX direction.

As shown in FIGS. 2 and 3, the focus ring 16b is a substantially annular member provided on the outer peripheral surface of the exterior unit 16 at a position adjacent to the subject side of the zoom ring 16a in the optical axis AX direction, and varies the position of the focus lens (lens L5) in the optical axis AX direction. As the focus ring 16b is turned, the fourth-fifth lens group unit 20 moves back and forth in the optical axis AX direction.

### (3) Configuration of Fourth-Fifth Lens Group Unit 20

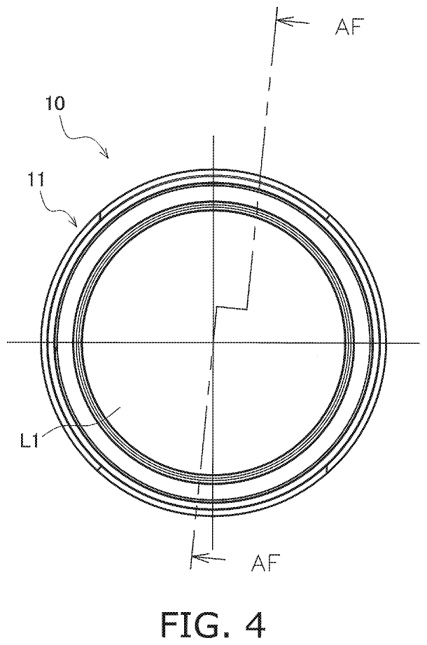

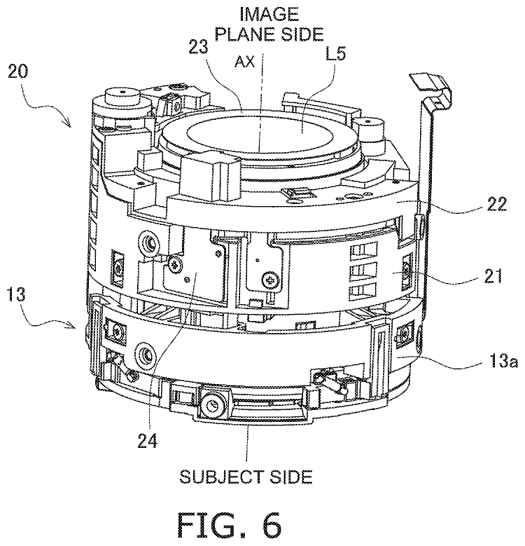

As shown in FIGS. 4 and 5, with the lens barrel 10 according to this embodiment, the fourth-fifth lens group unit 20, which is disposed on the inner peripheral surface side of the rectilinear guide barrel 15 and the cam barrel 17, is moved back and forth in the optical axis AX direction. At this point, the relative positions of the fourth lens group unit 21 and the fifth lens group unit 23 included in the fourth-fifth lens group unit 20 are detected using the optical position detection unit 24 shown in FIG. 6.

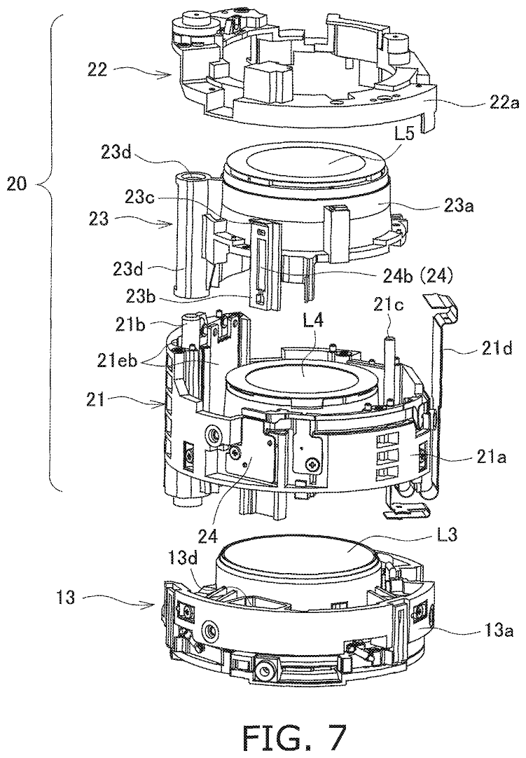

As shown in FIG. 6, the fourth-fifth lens group unit 20 is disposed on the image plane side of the third lens group unit 13, which is disposed on the subject side in the optical axis AX direction. As shown in FIG. 7, the fourth-fifth lens group unit 20 includes a fourth lens group unit 21, an outer frame 22, and a fifth lens group unit (lens movement frame) 23.

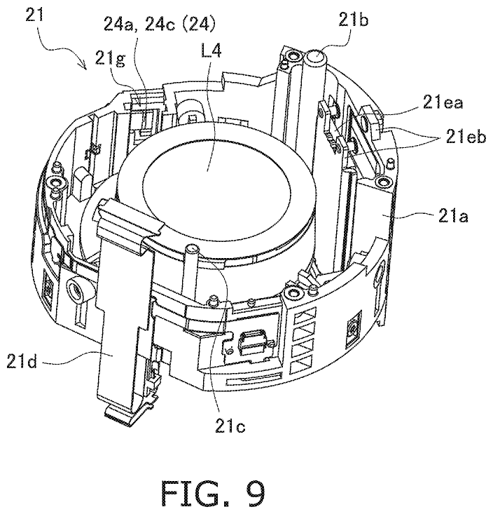

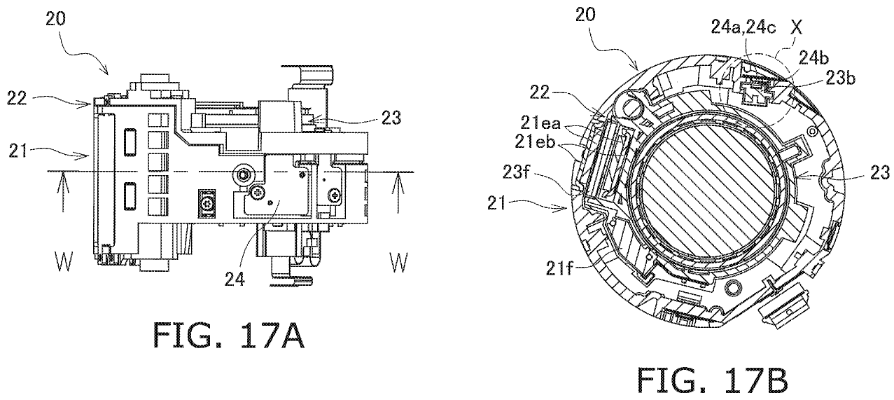

The fourth lens group unit 21 has a substantially cylindrical main body portion (first outer frame) 21a, a main shaft 21b, a sub-shaft 21c, a flexible printed circuit 21d, a linear magnet 21ea, a linear yoke 21eb, a hole 21g (see FIG. 9, etc.), and a light blocking wall (first light blocking wall) 21h (see FIG. 17).

The main body portion (first outer frame) 21a has a substantially cylindrical shape and holds the lens L4 at its center.

The main shaft 21b and the sub-shaft 21c are disposed in the main body portion 21a along the optical axis AX, the main shaft 21b is inserted into the guide hole 23d of the fifth lens group unit 23, and the sub-shaft 21c is inserted into the guide hole 21e.

Consequently, the fifth lens group unit 23 is guided in the optical axis AX direction by the main shaft 21b and the sub-shaft 21c, and moves relative to the fourth lens group unit 21;

The flexible printed circuit 21d is connected to the position detection unit 24 and supplies power to the light emitting unit 24a and the light receiving unit 24c.

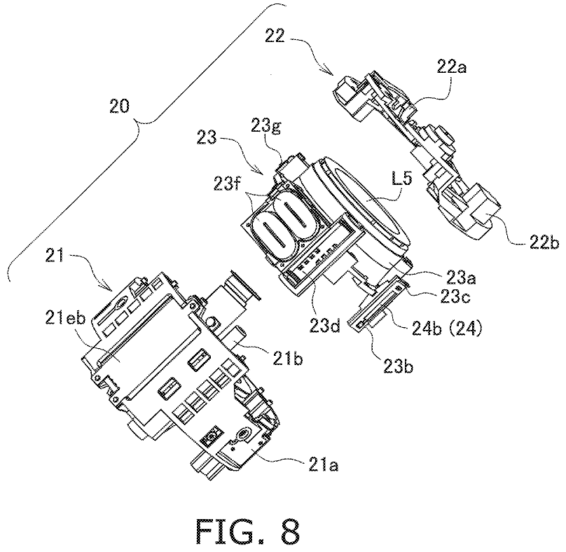

The linear magnet 21ea is disposed at a position opposite a linear coil 23f provided to the fifth lens group unit 23 shown in FIG. 8 (see FIG. 9).

As shown in FIG. 8, the linear yoke 21eb is provided on the outer and inner peripheral surfaces of the substantially cylindrical main body portion 21a, and is disposed in contact with the inner and outer radial surfaces of the linear magnet 21ea, respectively.

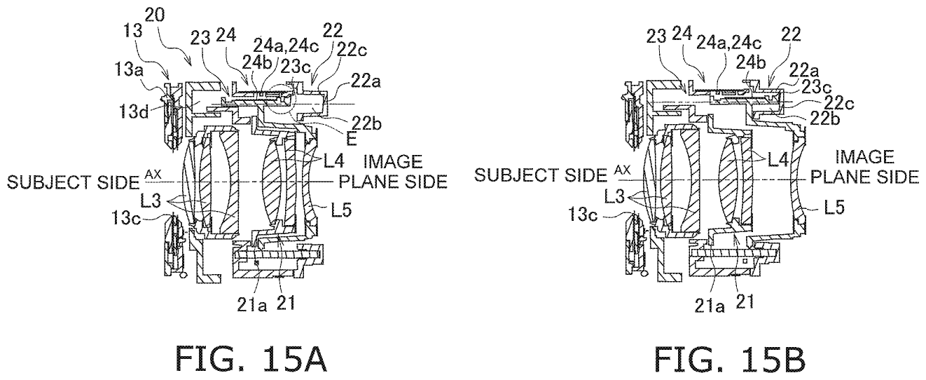

The hole 21g is provided as a through-hole that allows leaked light to escape in order to prevent light reflected by the bottom surface from reaching the image plane side if there is a bottom surface that is perpendicular to the optical axis AX direction of the main body portion 21a of the fourth lens group unit 21. In particular, the hole 21g forms a structure that actively allows leaked light to escape so that it does not reach the image plane side when fifth lens group unit 23 is at its limit position on the image plane side (see FIG. 15B).

When the fourth-fifth lens group unit 20 is assembled at a position adjacent to the third lens group unit 13, the enclosure 13d (see FIG. 13) is provided at a position in the third lens group unit 13 corresponding to the hole 21g.

The enclosure 13d is provided to the third lens group unit 13 to prevent light that has escaped to the subject side from being scattered inside the lens barrel 10 and reaching the image plane side. The enclosure 13d is provided to keep this light on its inside.

The light blocking wall (first light blocking wall) 21h (see FIG. 17) is an uneven wall surface where a reflecting plate holder 23b of the fifth lens group unit 23 on the movable side moves in a state of being very close.

The light leakage prevention structure using the light blocking wall 21h will be described in detail below.

The light emitting unit 24a and the light receiving unit 24c included in the position detection unit 24 are disposed on the inner peripheral surface of the substantially cylindrical main body portion 21a, at a position (the hole 21g) opposite the reflecting plate 24b of the fifth lens group unit 23 on the movable side, as shown in FIG. 9.

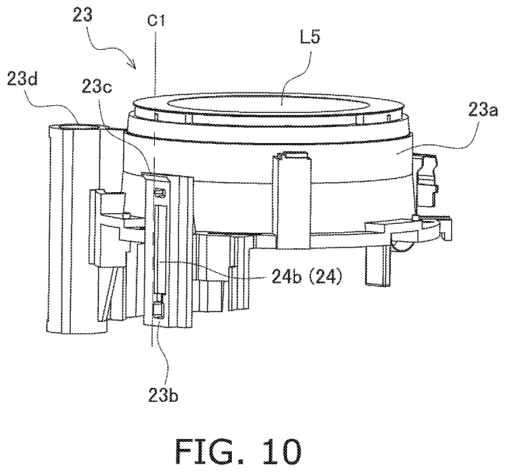

Also, as shown in FIG. 10, the reflecting plate 24b included in the position detection unit 24 is disposed at a position where the light emitted from the light emitting unit 24a will be reflected by the reflecting plate 24b and received by the light receiving unit 24c.

The outer frame 22 is fixed relative to the main body portion 21a of the fourth lens group unit 21, and has a substantially disk-shaped main body portion (second outer frame) 22a, a recess 22b (see FIG. 13), and an inclined surface 22c (see FIG. 13).

As shown in FIGS. 7 and 8, the main body portion (second outer frame) 22a is a substantially disk-shaped member that is disposed the closest to the image plane side out of the fourth-fifth lens group unit 20, and has a recess 22b provided at a position corresponding to the movable range of the reflecting plate holder 23b of the fifth lens group unit 23 on the movable side.

The recess 22b is provided to the main body 22a in a plane perpendicular to the optical axis AX so as to be recessed toward the image plane. When the fourth lens group unit 21 has moved to a position on the image plane side, the reflecting plate 24b provided to the reflecting plate holder 23b of the fifth lens group unit 23 is inserted into the recess 22b (see FIGS. 15A and 15B). The recess 22b has the inclined surface 22c (see FIG. 15A, etc.) on the concave bottom portion.

The inclined surface 22c is inclined obliquely outward in the radial direction with respect to a plane perpendicular to the optical axis AX (see FIG. 15A, etc.).

The light leakage prevention achieved by the inclined surface 22c will be discussed in detail below.

As shown in FIG. 10, the fifth lens group unit (lens movement frame) 23 holds the lens L5 and is provided in a state of being able to move in the optical axis AX direction of the lens L5 on the inner peripheral surface side of the main body portion 21a of the fourth lens group unit 21. The fifth lens group unit 23 has the main body portion 23a, the reflecting plate holder (holder) 23b, the protrusion 23c, the guide holes 23d and 23e, the linear coil 23f, the linear flexible printed circuit 23g, and the light blocking wall (second light blocking wall) 23h.

As shown in FIG. 8, the main body portion 23a is a substantially cylindrical member, and has the reflecting plate holder 23b (which holds the reflecting plate 24b), the linear coil 23f, and the like disposed on its outer peripheral surface side.

As shown in FIG. 10, the reflecting plate holder (holder) 23b is provided such that the light emitted from the light emitting unit 24a will be reflected by the reflecting plate 24b and received by the light receiving unit 24c.

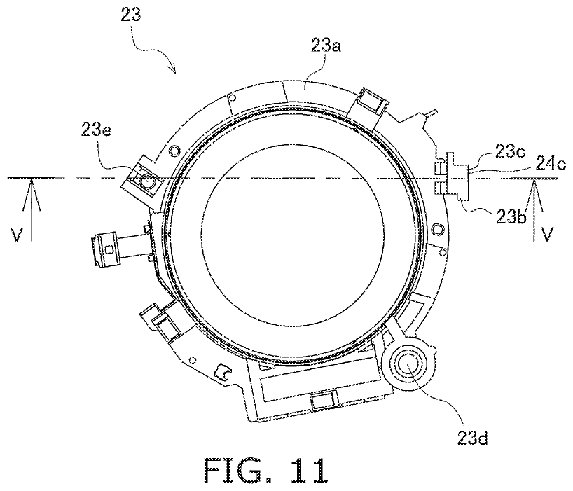

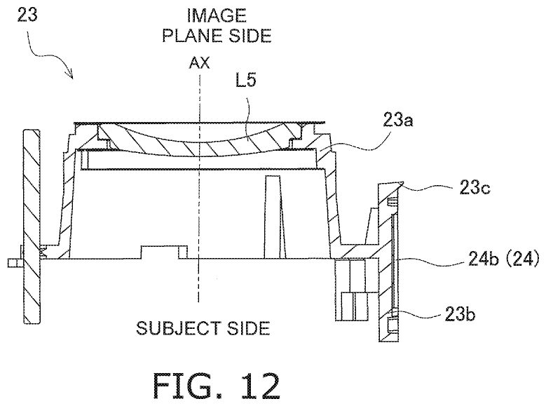

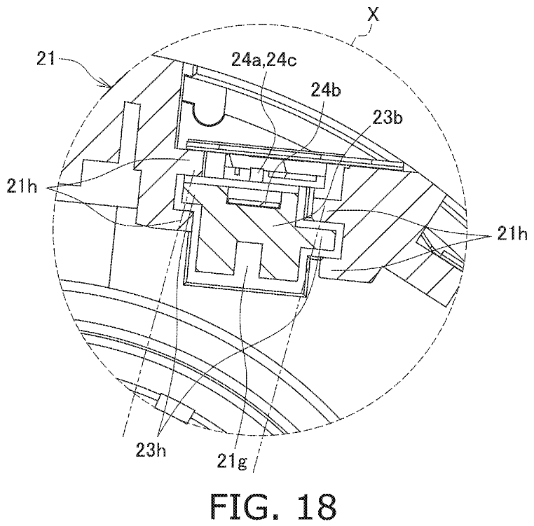

As shown in FIGS. 11 and 12, the protrusion 23c is provided to the fifth lens group unit 23 at a position on the image plane side, on the opposite side from the subject in the optical axis AX direction, and is provided so as to protrude outward in the radial direction beyond the light emitting unit 24a (see FIG. 18). As shown in FIG. 12, the protrusion 23c is provided at the end of the reflecting plate holder 23b on the image plane side in the optical axis AX direction. The protrusion 23c is provided at a position on the image plane side beyond the positions where the light emitting unit 24a, the light receiving unit 24c, and the reflecting plate 24b are disposed in the optical axis AX direction (see FIG. 15A, etc.). The protrusion 23c is disposed so as to cover the image plane side of the gap formed between the light emitting unit 24a and the light receiving unit 24c on one side and the reflecting plate 24b on the other.

As shown in FIG. 8, the linear coil 23f is disposed at a position opposite the linear yoke 21eb on the outer peripheral surface of the substantially cylindrical main body portion 23a. When the linear coil 23f is energized, an electromagnetic force is generated between the linear coil 23f and the linear yoke 21eb disposed at an opposing position, and this moves the fifth lens group unit 23 back and forth in the optical axis AX direction.

The linear flexible printed circuit 23g is provided on the outer peripheral surface of the main body portion 23a, is connected to the linear coil 23f, and supplies power to the linear coil 23f.

The light blocking wall (second light blocking wall) 23h is disposed in the fifth lens group unit 23 at a position opposite the light blocking wall 21h on the fourth lens group unit 21 side (see FIG. 17).

The light leakage prevention structure featuring the light blocking wall 23h will be described in detail below.

As shown in FIGS. 9 and 10, the position detection unit 24 has the light emitting unit 24a that emits light, the reflecting plate 24b that is located opposite the light emitting unit 24a and reflects the light emitted from the light emitting unit 24a, and the light receiving unit 24c that receives the light reflected by the reflecting plate (reflecting unit) 24b, and detects the position of the fifth lens group unit 23 relative to the fourth lens group unit 21 on the basis of the change in the amount of light received by the light receiving unit 24c.

As shown in FIG. 9, the light emitting unit 24a and the light receiving unit 24c are provided on the inner peripheral surface side of the substantially cylindrical main body portion 21a of the fourth lens group unit 21.

The light emitting unit 24a emits light onto the reflecting plate 24b disposed in an opposing position.

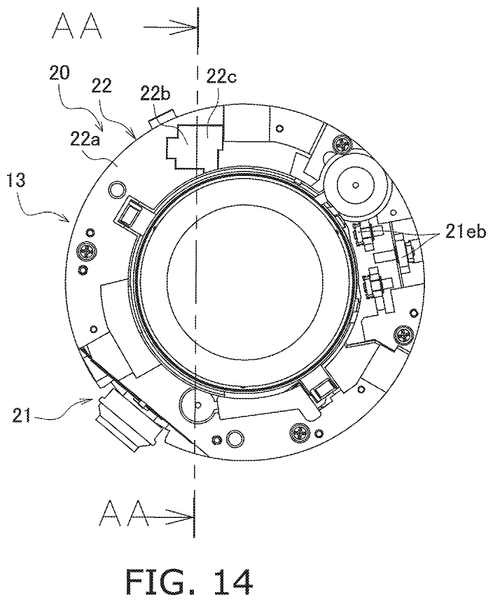

As shown in FIG. 7, the reflecting plate (reflecting unit) 24b is held in the reflecting plate holder 23b provided on the outer peripheral surface of substantially cylindrical main body portion 23a of the fifth lens group unit 23. As shown in FIGS. 14 and 15A, etc., the reflecting plate 24b is provided at a position opposite the light emitting unit 24a and the light receiving unit 24c of the fifth lens group unit 23. The reflecting plate 24b has a reflective surface whose reflectance varies in the optical axis AX direction, and the amount of reflected light changes when the position of fifth lens group unit 23 in the optical axis AX direction changes.

Furthermore, as shown in FIG. 15A, when the fifth lens group unit 23 moves toward the subject side, the reflecting plate 24b is inserted into the enclosure 13d provided on the third lens group unit 13 side.

Consequently, even if the light emitted from the light emitting unit 24a or the light reflected by the reflecting plate 24b is scattered inside the lens barrel 10, that light can be effectively prevented from reaching the image plane side by being kept inside the enclosure 13d.

Just as with the light emitting unit 24a, the light receiving unit 24c is provided on the inner circumferential surface of the main body portion 21a of the fourth lens group unit 21, and receives light that is emitted from the light emitting unit 24a and reflected by the reflecting plate 24b. In this embodiment, when there is a change in the relative position of the fifth lens group unit 23 with respect to the fourth lens group unit 21, the amount of light received by the light receiving unit 24c changes, and this allows the position to be detected.

### Light Leakage Prevention by Inclined Surface 22c

With the lens barrel 10 in this embodiment, as shown in FIG. 14, an inclined surface 22c is provided at the bottom of the recess 22b, and is formed so as to be inclined outward in the radial direction with respect to a line parallel to the optical axis AX along which the fourth lens group unit 21 moves.

As shown in FIG. 15A, in a state in which the fifth lens group unit 23 has moved to the position nearest the subject, light that has leaked from the gap between the light emitting unit 24a and the light receiving unit 24c on one side and the reflecting plate 24b on the other approaches the image plane while being scattered within the recess 22b. At this point, since the bottom surface of recess 22b is the inclined surface 22c that is inclined outward in the radial direction, the light scattered within the recess 22b faces outward in the radial direction, which makes it less likely that leaked light will head toward the image plane side from a gap on the radially inner side.

On the other hand, as shown in FIG. 15B, in a state in which the fifth lens group unit 23 has moved to the position nearest the image plane side, the reflecting plate holder 23b is in a state of having been inserted into the recess 22b.

Consequently, light that is scattered in the gap between the light emitting unit 24a and the light receiving unit 24c on one side and the reflecting plate 24b on the other stays within the recess 22b on the image plane side, which makes it less likely that leaked light will head toward the image plane side.

### Light Leakage Prevention Structure featuring Light Blocking Walls 21h and 23h

As shown in FIGS. 17A and 17B, with the lens barrel 10 of this embodiment, a light leakage prevention structure is provided in to the X portion where the light emitting unit 24a and the light receiving unit 24c provided to the fourth lens group unit 21 are opposite the reflecting plate 24b provided to the fifth lens group unit 23.

More specifically, the light blocking wall 21h provided to the fourth lens group unit 21 is provided as part of a wall that forms a space in which the reflecting plate holder 23b can be moved in the optical axis AX direction in the main body portion 21a of the fourth lens group unit 21. The light blocking wall 21h is formed so as to protrude in the circumferential direction, as shown in FIG. 18.

The light blocking walls 23h provided to the fifth lens group unit 23 are provided on the reflecting plate holder 23b, and are formed so as to protrude in the circumferential direction as shown in FIG. 18.

The light blocking walls 23h are provided on the two side surfaces of the reflecting plate holder 23b so as to be inserted between the two light blocking walls 21h on the fourth lens group unit 21 side.

In this embodiment, as shown in FIG. 18, the light blocking wall 21h of the fourth lens group unit 21 and the light blocking walls 23h of the fifth lens group unit 23 are disposed so as to overlap in the approximate radial direction (see the two-dot chain line in FIG. 18) when viewed in a cross section perpendicular to the optical axis AX based on the light emitting unit 24a.

Consequently, even if light is scattered in the gap between the light emitting unit 24a and the light receiving unit 24c on one side and the reflecting plate 24b on the other, the light can be confined in the maze-like gap formed between the light blocking wall 21h of the fourth lens group unit 21 and the light blocking walls 23h of the fifth lens group unit 23, which effectively prevents leaked light from heading toward the image plane.

### Main Features

As shown in FIG. 7, etc., the lens barrel 10 of this embodiment includes the substantially cylindrical fourth lens group unit 21, the fifth lens group unit 23, the position detection unit 24, and the protrusion 23c. The fifth lens group unit 23 holds the lens L5 and is provided on the inner peripheral surface of the fourth lens group unit 21 in a state of being able to move in the optical axis AX direction of the lens L5. The position detection unit 24 has the light emitting unit 24a that emits light, the reflecting plate 24b that is provided opposite the light emitting unit 24a and reflects the light emitted from the light emitting unit 24a, and the light receiving unit 24c that receives the light reflected by the reflecting plate 24b. The position detection unit 24 detects the position of the fifth lens group unit 23 relative to the fourth lens group unit 21 on the basis of the change in the amount of light received by the light receiving unit 24c. The protrusion 23c is provided at a position on the image plane side of the fifth lens group unit 23, which is on the opposite side from the subject in the optical axis AX direction, and is provided so as to protrude outward in the radial direction beyond the light emitting unit 24a.

Consequently, with the lens barrel 10 featuring the optical position detection unit 24 for detecting the position of the fifth lens group unit 23, the amount of light headed toward the imaging element 52, from among the leaked light emitted from the light emitting unit 24a of the position detection unit 24, is reduced by the protrusion 23c that is provided on the fifth lens group unit 23 side and protrudes outward in the radial direction beyond the light emitting unit 24a.

As a result, the leakage of light emitted from the light emitting unit 24a of the position detection unit 24 can be effectively prevented from adversely affecting the imaging element 52 on the camera body 51 side with a simple configuration.

### Other Embodiments

An embodiment of the present disclosure was described above, but the present disclosure is not limited to or by the above embodiment, and various modifications are possible without departing from the gist of the disclosure.
(A) In the above embodiment, an example was given in which the fourth lens group unit 21 included in fourth-fifth lens group unit 20 was used as the first outer frame of the present disclosure. However, the present disclosure is not limited to this.

For example, some other frame may be used as the first outer frame of the present disclosure.
(B) In the above embodiment, an example was given in which the fifth lens group unit 23 included in the fourth-fifth lens group unit 20 was used as the lens movement frame of the present disclosure. However, the present disclosure is not limited to this.

For example, some other lens frame may be used as the lens movement frame of the present disclosure.
(C) In the above embodiment, an example was given in which the protrusion 23c of the present disclosure was provided at the end of the reflecting plate holder 23b on the image plane side, but the present disclosure is not limited to this.

For example, the configuration may be such that the protrusion of the present disclosure is provided not to the reflecting plate holder (holder), but to another portion of the fifth lens group unit 23, or to a portion other than the fifth lens group unit.
(D) In the above embodiment, an example was given in which the light emitting unit 24a and the light receiving unit 24c were provided to the main body portion (first outer frame) 21a of the fourth lens group unit 21, and the reflecting plate (reflecting unit) 24b was provided to the fifth lens group unit (lens movement frame) 23. However, the present disclosure is not limited to this.

For example, the light emitting unit and the light receiving unit may be provided to the lens moving frame, and the reflecting unit may be provided to the first outer frame.
(E) In the above embodiment, an example was given in which the configuration of the present disclosure was applied to the lens barrel 10 that is removably attached to the camera body 51. However, the present disclosure is not limited to this.

For example, the configuration of the present disclosure may be applied to a lens barrel that is fixed in an undetachable state to a camera body.

### Addenda

The above description of the embodiments discloses the following techniques.

### Technique 1:

The lens barrel according to Technique 1 comprises:
a first outer frame having a substantially cylindrical shape;
a lens movement frame that holds a lens and is provided on the inner peripheral surface side of the first outer frame in a state of being movable in the optical axis direction of the lens;
a position detection unit that has a light emitting unit that emits light, a reflecting unit that is provided at a position opposite the light emitting unit and reflects the light emitted from the light emitting unit, and a light receiving unit that receives the light reflected by the reflecting unit, the position detection unit detecting the position of the lens movement frame with respect to the first outer frame on the basis of the change in the amount of light received by the light receiving unit; and
a protrusion that is provided at a position on the lens movement frame on the image plane side, which is on the opposite side from the subject in the optical axis direction, the protrusion being provided so as to protrude radially outward beyond the light emitting unit.

### Technique 2:

The lens barrel according to Technique 2 is the lens barrel according to Technique 1,
wherein the protrusion is provided at a position closer to the image plane side in the optical axis direction than the positions where the light emitting unit, the light receiving unit, and the reflecting unit are disposed.

### Technique 3:

The lens barrel according to Technique 3 is the lens barrel according to Technique 1 or 2,
wherein the light emitting unit and the light receiving unit are provided to the first outer frame, and
the reflecting unit is provided at a position on the lens movement frame that is opposite the light emitting unit and the light receiving unit.

### Technique 4:

The lens barrel according to Technique 4 is the lens barrel according to any of Techniques 1 to 3,
wherein the protrusion is disposed so as to cover the image plane side in a gap having the light emitting unit and the light receiving unit on one side and the reflecting unit on the other side.

### Technique 5:

The lens barrel according to Technique 5 is the lens barrel according to Technique 3,
wherein the lens movement frame has a holder that holds the reflecting unit, and the protrusion is provided at an end of the holder.

### Technique 6:

The lens barrel according to Technique 6 is the lens barrel according to any of Techniques 1 to 5,
wherein the first outer frame has a first light blocking wall provided near the light emitting unit,
the lens movement frame has a second light blocking wall disposed at a position opposite the first light blocking wall, and
in a cross-sectional view taken in a direction perpendicular to the optical axis using the light emitting unit as a reference, the first light blocking wall and the second light blocking wall are disposed so as to overlap in the radial direction.

### Technique 7:

The lens barrel according to Technique 7 is the lens barrel according to any of Techniques 1 to 6,
further comprising a third outer frame that is provided on the subject side of the lens movement frame in the optical axis direction, and that has a substantially cylindrical main body portion and an enclosure provided on the subject side of the main body portion in the optical axis direction,
wherein the reflecting unit provided to the lens movement frame is inserted into the enclosure when the lens movement frame moves to a position on the subject side.

### Technique 8:

The lens barrel according to Technique 8 is the lens barrel according to any of Techniques 1 to 7,
wherein the first outer frame further has a hole that allows light to escape to the subject side.

### Technique 9:

The lens barrel according to Technique 9 is the lens barrel according to any of Techniques 1 to 8,
further comprising a second outer frame that has a recess provided so as to be recessed toward the image plane side, and that is fixed relative to the first outer frame,
wherein the reflecting unit of the lens movement frame is inserted into the recess when the lens movement frame moves to a position on the image plane side.

### Technique 10:

The lens barrel according to Technique 10 is the lens barrel according to Technique 9, wherein the recess has a bottom surface, and
the bottom surface is inclined obliquely outward in the radial direction with respect to a plane perpendicular to the optical axis.

### Technique 11:

The imaging device according to Technique 11 comprises:
the lens barrel according to claim any of Techniques 1 to 10; and
a camera body to which the lens barrel is attached.

### INDUSTRIAL APPLICABILITY

The lens barrel of the present disclosure is configured to employ an optical position detection unit for detecting the position of a lens movement frame, and exhibits the effect that leaked light emitted from the light emitting unit of the position detection unit can be prevented from leaking and adversely affecting the image sensor on the camera body with a simple configuration, and as such is widely applicable to various kinds of lens barrel that are attached to an imaging device.

### REFERENCE SIGNS LIST

10 lens barrel
11 first lens group unit
12 second lens group unit
12a main body portion
12b cam follower
13 third lens group unit (third outer frame)
13a main body portion
13b cam follower
13c aperture unit
13d enclosure
14 sixth lens group unit
14a main body portion
14b cam follower
15 rectilinear guide cylinder
15a main body portion
15b rectilinear groove
16 exterior unit
16a zoom ring
16b focus ring
17 cam barrel
17a to 17e cam grooves
20 fourth-fifth lens group unit
20a main body portion
20b cam follower
21 fourth lens group unit
21a main body portion (first outer frame)
21b main shaft
21c sub-shaft
21d flexible printed circuit
21ea linear magnet
21eb linear yoke
21g hole
21h light blocking wall (first light blocking wall)
22 outer frame
22a main body portion (second outer frame)
22b recess
22c inclined surface
23 fifth lens group unit (lens movement frame)
23a main body portion
23b reflecting plate holder (holder)
23c protrusion
23d guide hole
23e guide hole
23f linear coil
23g linear flexible printed circuit
23h light blocking wall (second light blocking wall)
24 position detecting unit
24a light emitting unit
24b reflecting plate (reflecting unit)
24c light receiving unit5
50 camera (imaging device)
51 camera body
AX optical axis
C1 center axis
L1 to L6 lenses

1. A lens barrel, comprising:
a first outer frame having a substantially cylindrical shape;
a lens movement frame that holds a lens and is provided on a side of an inner peripheral surface of the first outer frame in a state of being movable in an optical axis direction of the lens;
a position detection unit that has a light emitting unit configured to emit light, a reflecting unit that is provided at a position opposite the light emitting unit and configured to reflect the light emitted from the light emitting unit, and a light receiving unit configured to receive the light reflected by the reflecting unit, the position detection unit configured to detect the position of the lens movement frame with respect to the first outer frame on the basis of a change in an amount of light received by the light receiving unit; and
a protrusion that is provided at the position on the lens movement frame on an image plane side, which is on an opposite side from a subject in the optical axis direction, the protrusion being provided so as to protrude radially outward beyond the light emitting unit.

2. The lens barrel according to claim 1,
wherein the protrusion is provided at a position closer to the image plane side in the optical axis direction than the positions where the light emitting unit, the light receiving unit, and the reflecting unit are disposed.

3. The lens barrel according to claim 1,
wherein the light emitting unit and the light receiving unit are provided to the first outer frame, and
the reflecting unit is provided at a position on the lens movement frame that is opposite the light emitting unit and the light receiving unit.

4. The lens barrel according to claim 1,
wherein the protrusion is disposed so as to cover the image plane side in a gap between the light emitting unit and the light receiving unit on one side and the reflecting unit on the other side.

5. The lens barrel according to claim 3,
wherein the lens movement frame has a holder that holds the reflecting unit, and
the protrusion is provided at an end of the holder.

6. The lens barrel according to claim 1,
wherein the first outer frame has a first light blocking wall provided near the light emitting unit,
the lens movement frame has a second light blocking wall disposed at a position opposite the first light blocking wall, and
in a cross-sectional view taken in a direction perpendicular to the optical axis using the light emitting unit as a reference, the first light blocking wall and the second light blocking wall are disposed so as to overlap in a radial direction.

7. The lens barrel according to claim 1,
further comprising a third outer frame that is provided on a subject side of the lens movement frame in the optical axis direction, and that has a substantially cylindrical main body portion and an enclosure provided on the subject side of the main body portion in the optical axis direction,
wherein the reflecting unit provided to the lens movement frame is inserted into the enclosure when the lens movement frame moves to a position on the subject side.

8. The lens barrel according to claim 1,
wherein the first outer frame further has a hole configured to allow light to escape to a subject side.

9. The lens barrel according to claim 1,
further comprising a second outer frame that has a recess provided so as to be recessed toward the image plane side, and that is fixed relative to the first outer frame,
wherein the reflecting unit of the lens movement frame is inserted into the recess when the lens movement frame moves to a position on the image plane side.

10. The lens barrel according to claim 9,
wherein the recess has a bottom surface, and
the bottom surface is inclined obliquely outward in a radial direction with respect to a plane perpendicular to the optical axis.

11. An imaging device, comprising:
the lens barrel according to claim 1; and
a camera body to which the lens barrel is attached.
